(19) United States
(12) Patent Application Publication
(10) Pub. No.: US 2024/0315810 A1
(43) Pub. Date: Sep. 26, 2024

(54) DENTAL SUB-ASSEMBLY FOR INDIVIDUAL PROSTHETIC RESTORATION OF A TOOTH, AND A FIRST ELEMENT INTENDED TO BE JOINED THERETO

(71) Applicant: ANTHOGYR, Sallanches (FR)

(72) Inventor: Hervé Richard, Notre Dame de Bellecombe (FR)

(21) Appl. No.: 18/278,247

(22) PCT Filed: Mar. 11, 2022
(86) PCT No.: PCT/IB2022/052198

§ 371 Date: Aug. 22, 2023

(30) Foreign Application Priority Data
Mar. 16, 2021 (EP) 21162982.9

(51) Int. Cl. A61C 8/00

(52) U.S. Cl. CPC A61C 8/0054; A61C 8/0066; A61C 8/0068

(57) ABSTRACT

A dental sub-assembly for individual prosthetic restoration of a tooth is shaped so as to be received on a dental implant. The dental sub-assembly is able to be assembled with a first element in the form of a core on which stratification is performed, or in the form of a ceramic core. The first element has a first through-passage. The dental sub-assembly includes a ring intended to be fitted into the first through-passage of the first element and to be retained firmly in order to form there a seat for a first fastening screw intended to be screwed into the dental implant.

### TECHNICAL FIELD OF THE INVENTION

The present invention concerns the field of dental restoration and more particularly concerns:
a dental sub-assembly for individual prosthetic restoration of a tooth, shaped to be received on a dental implant, said dental sub-assembly being adapted to be assembled with a first element of core type on which stratification is performed or of ceramic core type, and
a first element for individual prosthetic restoration of a tooth, of core type on which stratification is performed or of ceramic core type intended to be received on said dental sub-assembly.

In the context of individual prosthetic restoration of a tooth there is often used a through-fixed prosthesis, that is to say one having a through-passage enabling (direct or indirect) fixing of the prosthesis by a fastening screw (passing through the prosthesis) fixing it to a dental implant that is osteo-integrated into the jaw of the patient.

Different types of through-fixed prostheses are known:
those including a core (in particular a metal core) on which stratification is performed by the prosthesis practitioner, leaving the through-passage open (application of one or more layers of a material enabling an appearance as close as possible to a natural tooth to be imparted);
those including a ceramic core (machined from a block of ceramic or produced in particular by sintering a ceramic powder) possibly coated by the prosthesis practitioner with one or more very light texturing or coloring layers achieving an appearance as close as possible to a natural tooth.

Depending on the position of the dental implant fixed into the jaw of the patient, it is often necessary carefully to adjust the location of the annular outlet of the well enabling the passage of the fastening screw. In fact it is a question of being in a position, despite the lack of room available in the mouth of the patient, to access the fastening screw using a screwdriving tool. It is moreover important that when chewing the annular outlet of the access well is disposed away from the active parts of the tooth (cuspids or free edge).

The documents EP 3 202 365 B1 and US 2017/0224447 A1 in the name of the present applicant have proposed a solution enabling fixing onto a dental implant a through-fixed dental prosthesis including a core on which stratification is performed or including a ceramic core, allowing recourse to an angled through-passage to take account of the constraints on the orientation of the osteo-integrated dental implant, accessibility, and preservation of the active parts of the tooth, without unnecessarily weakening the mechanical strength of said through-fixed dental prosthesis.

To this end, the teaching is to have recourse to a second element provided with flexible longitudinal fins the free edges of which are intended to be engaged in an annular groove formed in a core-type first element on which stratification is performed or of ceramic core type. The first element is shaped according to the preamble of claim 16.

For the first element to be retained on the second element and pressed against the second element in a satisfactory manner it is necessary to manufacture the first element with very high precision, in particular where the groove and its frustoconical part against which the free edges of the longitudinal fins are intended to come to bear are concerned. The precision required is unfortunately so high that it is most often incompatible with the manufacturing capabilities of the machines generally used by dental prosthesis practitioners to produce the first element.

Moreover, dental prosthesis practitioners must make sure that the second element can be reliably mounted on a first element. This implies minutely controlling the geometry of the groove and more particularly of its frustoconical part. However, dental prosthesis practitioners most often do have control means adapted to do this.

The documents US 2019/0365510 A1 and WO 2018/138630 A1, also in the name of the present applicant, propose an alternative solution having recourse to a fixing part mounted on and fixed to a dental implant. The fixing part can be expanded by screwing a screw into the dental implant and its expansion enables retention on the dental implant of a first element conforming to the preamble of claim 16.

The document US 2001/0044095 A1 describes a dental sub-assembly conforming to the preamble of claim 1.

### SUMMARY OF THE INVENTION

One problem addressed by the present invention is to provide another solution for fixing onto a dental implant a through-fixed dental prosthesis including a core on which stratification is performed or a ceramic core, allowing recourse to an angled through-passage to take account of constraints of orientation of the osteo-integrated dental implant, accessibility, and preservation of the active parts of the tooth, without unnecessarily weakening the mechanical strength of said through-fixed dental prosthesis.

At the same time, the invention aims to provide another fixing solution that is compatible with the manufacturing capabilities of the machines generally used by dental prosthesis practitioners to produce the first element.

To achieve the above and other objects the invention firstly proposes a dental sub-assembly for the individual prosthetic restoration of a tooth, shaped to be received on a dental implant, said dental sub-assembly being adapted to be assembled with a first element of core type on which stratification is performed or of ceramic core type, said first element including a first through-passage including a first passage section extending from a proximal end of said first element along a first longitudinal axis, said first element including at least a first rotation indexing member and a first axial retaining member, said dental sub-assembly including:
a second element with a second through-passage extending along a second longitudinal axis, including a bearing surface shaped to be able to receive in axial bearing engagement said first element and including a proximal end shaped to be able to come to bear axially against or shaped to be able to come to penetrate into said dental implant,
a first fastening screw including a first screw head from which extends a first screw shank adapted to pass through the second element, being received in the second through-passage and having an externally-threaded section shaped to be received by screwing in said dental implant, the first screw head being sized so as to enable it to be received by axial penetration in the first passage section along the first longitudinal axis from the proximal end of the first element,
a ring shaped to form a seat for the first screw head and shaped to be mounted on and retained in said first element by axial penetration along the first longitudinal axis in the first passage section from the proximal end of said first element as far as a predetermined axial position in which locking means are able to oppose movement in translation of the ring in the direction of the proximal end of said first element;

according to the invention:
said second element includes at least a second rotation indexing member and a third rotation indexing member,
the ring includes at least one fourth rotation indexing member,
the third and fourth rotation indexing members are shaped to interlock by axial inter-penetration along the second longitudinal axis when the second element and the ring are in a penetration orientation relative to one another about the second longitudinal axis so that in an interlocked position the third and fourth rotation indexing members block rotation of the ring relative to the second element about the second longitudinal axis,
the first and second rotation indexing members are shaped to interlock with one another by axial interpretation along the second longitudinal axis when said first element and the second element are in a penetration orientation relative to one another about the second longitudinal axis, so that in an interlocked position the first and second rotation indexing members block rotation of said first element relative to the second element about the second longitudinal axis,
in its predetermined axial position the ring can be pivoted about the first longitudinal axis until it reaches a locking orientation in which the first axial retaining member opposes movement in translation of the ring in the direction of the proximal end of said first element.

A sub-assembly of this kind requires a precision in manufacturing the first element that is much lower than that necessary to produce the first element described in European patent EP 3 202 365 B1. Most machines generally used by dental prosthesis practitioners can therefore be used to manufacture this first element.

When the ring is not in said at least one locking angular orientation the first, the second, the third and the fourth indexing members may advantageously form axial abutments preventing the bearing surface of the second element from coming to bear axially against the proximal end of said first element.

This is a simple and readily-perceptible way to ensure that the ring (which is engaged in the first element and therefore hard to see or even invisible) is in a correct locking angular orientation in the first element as soon as the bearing surface of the second element bears axially against the proximal end of the first element.

First friction means may preferably enable the second element to be driven into said first element with a friction fit slowing movement in translation of the second element away from said first element along the first longitudinal axis.

A friction fit makes it possible to limit the risks of untimely separation of the first and second elements and the risks of the latter being lost or swallowed by the patient before fixing it to the implant.

To facilitate manipulation by the practitioner and to limit further the risks of untimely loss the ring may advantageously be captive on the shank of the first screw.

The third and fourth rotation indexing members preferably comprise:
on one of the ring or the second element at least one longitudinal fin,
on the other of the ring or the second element a cylindrical section with a tubular lateral wall including at least one longitudinal slot adapted to receive said at least one longitudinal fin.

The third and fourth rotation indexing members therefore have a simple structure compatible with mutual interlocking by axial inter-penetration.

Said at least one second rotation indexing member may advantageously comprise a radial projection at the periphery of a cylindrical section of the second element, said radial projection being adapted to be engaged in the first rotation indexing member that is itself in the form of a longitudinal groove in the lateral wall of the first passage section of said first element when the bearing surface of the second element receives axially bearing on it the proximal end of said first element.

The first and second rotation indexing members therefore have a simple structure compatible with mutual interlocking by axial inter-penetration.

It is preferable if:
the ring comprises a radial protuberance at the periphery of the ring, said radial protuberance being adapted, when the ring is in the locking orientation, to bear against the first axial retaining member, which is itself in the form of a shoulder in the first passage section of said first element,
said radial protuberance is shaped so as to be able to slide axially in said longitudinal groove during the axial penetration of the ring into the first passage section of said first element.

For its engagement in the first element the ring with the radial protuberance therefore ingeniously cooperates with the structure of the first rotation indexing member, which enables an effective and compact implementation. Said radial protuberance and the first axial retaining member cooperate in a similar manner to a bayonet locking system and are therefore intuitive in use.

On said second element said radial projection and said longitudinal slot or longitudinal fin may advantageously be offset angularly relative to one another about the second longitudinal axis.

The ring may preferably include second friction means which, when the ring is in the locking orientation, are able to slow rotation of the ring relative to the first element about the first longitudinal axis. The second friction means therefore contribute to stabilizing the ring and maintaining it in the locking orientation before the practitioner assembles the first and second elements.

The second through-passage of the second element may advantageously include:
a seat for the head of a second screw adapted to pass through the second element, being received in the second through-passage to be screwed into the dental implant,
a distal internal thread adapted to receive a third screw enabling fixing to the second element of a temporary through-fixed element.

The distal internal thread and the third screw enable fixing to and removal from the second element of at least one temporary through-fixed element, for example:
a healing part the lateral wall of which is shaped to come at least in part into contact with the gum, and/or
an impression-taking part shaped to be scanned intra-orally and/or overmolded in an impression-taking compound, and/or
a temporary dental prosthesis.

The second element can therefore remain fixed to the implant from healing up to final restoration by fixing the first element. The soft tissues (gums) of the patient are therefore able to be reshaped all around the second element and above the dental implant without being disturbed: once the second element has been mounted on and fixed to the dental implant (preferably when the dental implant is fitted) there is no need to remove it and so the attachment of the connective tissues is not interfered with, which leads to better stability of the soft tissues. This also contributes to reducing the risk of vertical bone loss, the gum coming into good sealed contact all around the second element.

To ensure reliable identification of the orientation of the implant and the final orientation that the first element will have the temporary through-fixed element may preferably be indexed in rotation on the second element.

The invention secondly proposes a first element for the individual prosthetic restoration of a tooth of core type on which stratification is performed or of ceramic core type, said first element including a first through-passage including a first passage section extending from a proximal end of said first element along a first longitudinal axis, said first element including a first axial retaining member,

said first element can be assembled tp a dental sub-assembly that is itself shaped to be received on a dental implant and including:
a second element including a second through-passage extending along a second longitudinal axis, including a bearing surface shaped to be able to receive in axial bearing engagement the proximal end of said first element and having a proximal end shaped to be able to come to bear axially against or shaped to be able to come to penetrate into said dental implant,
a first fastening screw including a first screw head from which extends a first screw shank adapted to pass through the second element, being received in the second through-passage and having an externally-threaded section shaped to be received by screwing in said dental implant, the first passage section of the first element being sized so as to enable the reception of the first screw head by axial penetration along the first longitudinal axis from the proximal end of the first element,
a ring shaped to form a seat for the first screw head and to be mounted in said first element by axial penetration along the first longitudinal axis in the first passage section from the proximal end of said first element to a predetermined axial position in which locking means are able to oppose movement in translation of the ring in the direction of the proximal end of said first element,
said second element including at least a second rotation indexing member and a third rotation indexing member,
the ring including at least one fourth rotation indexing member,
the third and fourth rotation indexing members being shaped to interlock by axial inter-penetration along the second longitudinal axis when the second element and the ring are in a penetration orientation relative to one another about the second longitudinal axis so that in an interlocked position the third and fourth rotation indexing members block rotation of the ring relative to the second element about the second longitudinal axis, according to the invention:
said first element includes at least one first rotation indexing member,
the first and second rotation indexing members are shaped to interlock by axial inter-penetration along the second longitudinal axis when said first element and the second element are in a penetration orientation relative to one another about the second longitudinal axis so that in an interlocked position the first and second rotation indexing members block rotation of said first element relative to the second element about the second longitudinal axis,
the first passage section of said first element is shaped so that in its predetermined axial position the ring can be pivoted about the first longitudinal axis into a locking orientation in which the first axial retaining member opposes movement in translation of the ring in the direction of the proximal end of said first element.

A first element of this kind requires a manufacturing precision much lower than that necessary to produce the first element described in European patent EP 3 202 365 B1 and so most of the machines generally used by dental prosthesis practitioners can therefore be used to manufacture this first element. In fact, the predetermined axial position of the ring in the first element, effected by the first axial retaining member, does not need to be rigorously precise along the first longitudinal axis: small variations in this axial position can easily be made up by screwing the first fastening screw more or less into the implant, until the proximal end of the first element is brought to bear axially against the bearing surface of the second element.

When the ring is not in said at least one locking angular orientation the first, second, third and fourth indexing members advantageously form axial abutments preventing the bearing surface of the second element from coming to bear axially against the proximal end of said first element.

This is a simple and readily perceptible way to ensure that the ring (which is engaged in the first element and therefore little if at all visible) is indeed in a locking angular orientation in the first element as soon as the bearing surface of the second element bears axially against the proximal end of said first element.

First friction means may preferably enable a friction fit of the second element in said first element slowing movement in translation of the second element away from said first element along the first longitudinal axis.

The friction fit makes it possible to limit the risks of untimely separation of the first and second elements and the risks of the latter being lost or swallowed by the patient before fixing to the implant.

Said first rotation indexing member is advantageously in the form of a longitudinal groove formed in the lateral wall of the first passage section of said first element and in which a radial projection forming the second rotation indexing member of the second element can be engaged when the bearing surface of the second element receives in axial bearing engagement the proximal end of said first element.

The first and second rotation indexing members therefore have a simple structure compatible with mutual interlocking by axial inter-penetration.

It is referable if:
the first axial retaining member is in the form of a shoulder in the first passage section of said first element,
the ring includes a radial protuberance at the periphery of the ring, said radial protuberance being adapted to bear against the shoulder when the ring is in the locking orientation.

Said radial protuberance and the first axial retaining member cooperate in a similar manner to a bayonet locking system and are therefore intuitive in use.

Moreover, a first axial retaining member in the form of a shoulder is easy to manufacture by most of the machines generally used by dental prosthesis practitioners and its correct shape can be controlled with very simple control means (a simple rod mounted on a support plane and provided at its free end with a radial swelling adapted to come to bear against the shoulder may suffice).

The first through-passage advantageously further includes a second passage section, said second passage section obliquely extending the first passage section so that the first and second passage sections form a non-zero angle between them.

Such an angle enables careful adjustment of the location of the annular outlet of the second passage section allowing the passage of a screwdriving tool by ensuring that said annular outlet of the second passage section is disposed away from the active parts of the tooth (cuspids or free edge) when chewing. To drive the first fastening screw in rotation recourse may for example be had to a tool enabling angulation with the screw head when screwing or unscrewing, as described for example in the document EP 2 607 722 A1.

In accordance with another aspect of the present invention there is proposed a dental component comprising:
a dental sub-assembly as described above, and
a first element as described above.

In accordance with a further aspect of the present invention there is proposed a method for ex-vivo preliminary assembly for the subsequent assembly of a dental component of this type, comprising the following steps:
a) inserting the shank of the first screw in the ring,
b) inserting the ring and the first screw head in the first passage section by axial movement in translation along the first longitudinal axis from the proximal end of the first element so as to cause the ring to reach the predetermined axial position,
c) causing the ring to pivot about the first longitudinal axis to bring it into the locking orientation.

It is then possible to manipulate a single part and to mount the resulting preliminary assembly (formed by the screw, the ring and the first element) onto the second element present in the mouth of the patient and around which the connective tissues have previously formed a good attachment. The dental component is then fastened by screwing the screw into the dental implant: the screw head exerts a traction force on the first element (via the ring forming a screw seat in said first element) for reliably fixing it to the second element with the proximal end of the first element bearing against the bearing surface of the second element.

Alternatively, it is then possible to manipulate a single part and to mount the resulting preliminary assembly (formed by the screw, the ring and the first element) onto a second element present in the mouth of the patient. The second element is then mounted on the proximal end of the first element by engaging the shank of the first screw in the second through-passage until the bearing surface of the second element is brought to bear against the proximal end of the first element.

### BRIEF DESCRIPTION OF THE DRAWINGS

Other objects, features and advantages of the present invention will emerge from the following description of particular embodiments given with reference to the appended figures, in which:

FIG. 1 is a side view partly in section of a dental sub-assembly in accordance with one particular embodiment of the present invention, said sub-assembly comprising a second element, a ring and screw;

FIG. 2 is a perspective view of the second element of the sub-assembly from FIG. 1;

FIG. 3 is a view from above of the second element of the sub-assembly from FIG. 1;

FIG. 4 is a perspective view of the ring of the sub-assembly from FIG. 1;

FIG. 5 is a view from below of the ring of the sub-assembly from FIG. 1;

FIG. 6 is a side view in section of the ring of the sub-assembly from FIG. 1;

FIG. 7 is a view from behind of a first element in accordance with one particular embodiment of the present invention;

FIG. 8 is a side view of the first element from FIG. 7;

FIG. 9 is a side view in section of the first element from FIG. 7;

FIG. 10 is a first view in cross section of the first element from FIG. 7;

FIG. 11 is a second view in cross section of the first element from FIG. 7;

FIG. 12 is a perspective view of one step in the production of a preliminary assembly including the screw from FIG. 1, the ring from FIG. 4 and the first element from FIG. 7;

FIG. 13 is a perspective view of a later step in the production of the preliminary assembly from FIG. 12;

FIG. 14 is a perspective view of the assembly of a dental component in accordance with one particular embodiment of the present invention;

FIG. 15 is a side view of a part of the dental component from FIG. 14 during assembly;

FIG. 16 is a side view of the dental component from FIG. 14 after assembly;

FIG. 17 is another side view of a part of the dental component from FIG. 14 during assembly;

FIG. 18 is another perspective view of the assembly of the dental component from FIG. 16 onto a dental implant;

FIG. 19 is a view in longitudinal section of the dental component from FIG. 16 fixed onto a dental implant;

FIG. 20 is a perspective view showing the fixing of a healing part onto a dental implant by means of the second element from FIG. 2;

FIG. 21 is a side view of FIG. 20;

FIG. 22 is a perspective view showing the fixing of a temporary pillar body intended to be used to form a temporary dental prosthesis on a dental implant by means of the second element from FIG. 2; and

FIG. 23 is a side view of FIG. 22.

### DESCRIPTION OF PREFERRED EMBODIMENTS

When identical reference numbers are used in more than one figure, variant or embodiment of the invention those reference numbers designate identical or similar elements in each of the figures, each of the variants or each of the embodiments.

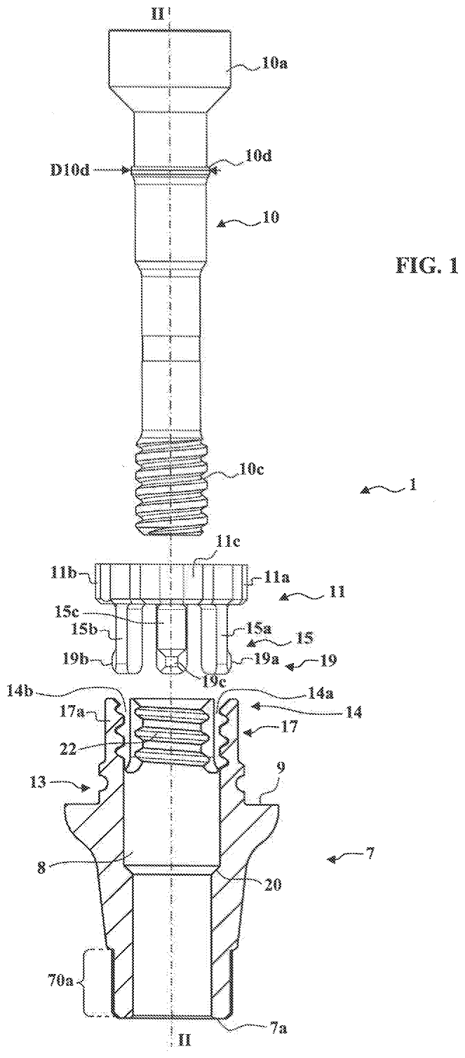

In FIG. 1 there is depicted by way of example an embodiment of a dental sub-system 1 for individual prosthetic restoration of a tooth shaped to be received on a dental implant 2 (FIG. 19).

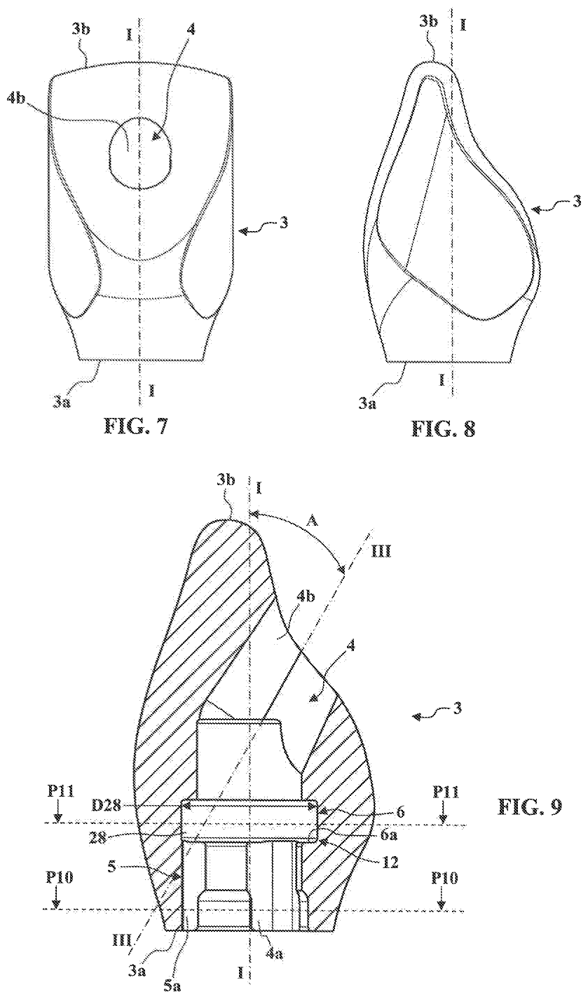

Said dental sub-assembly 1 is intended to be assembled with a first element 3 (FIGS. 7 to 11) of core type on which stratification is performed or of ceramic core type, said first element 3 having a first through-passage 4 including a first passage section 4a extending from a proximal end 3a of said first element 3 along a first longitudinal axis I-I, said first element 3 including at least a first rotation indexing member 5 and a first axial retaining member 6.

The shape of the cross section of the first passage section 4a varies along the first longitudinal axis I-I as depicted in FIGS. 10 and 11 on two distinct cross section planes P10 and P11.

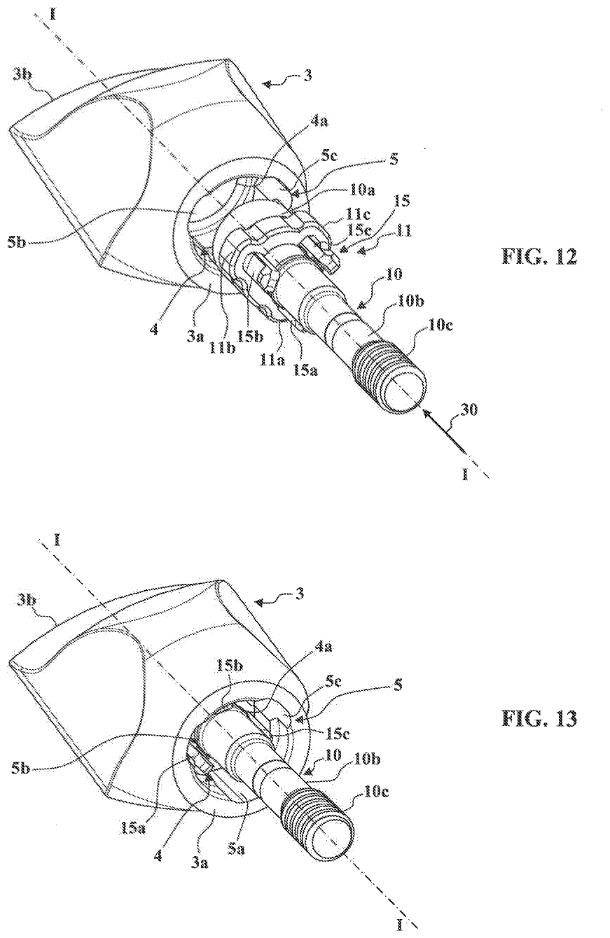

The dental sub-assembly 1 includes:
a second element 7 (FIGS. 1 to 3) with a second through-passage 8 extending along a second longitudinal axis II-II, including a bearing surface 9 shaped to be able to receive in axial bearing engagement the proximal end 3a of said first element 3 and including a proximal end 7a shaped to be able to bear in axial abutment against said dental implant 2 or shaped to be able to come to penetrate into said dental implant 2 (FIG. 19),
a first fastening screw 10 including a first screw head 10a from which extends a first screw shank 10b adapted to pass through the second element 7 by virtue of being received in the second through-passage 8 and provided with an externally-threaded section 10c shaped to be screwed into said dental implant 2 (FIG. 19), the first passage section 4a of the first element 3 being sized so as to enable reception of the first screw head 10a by axial penetration along the first longitudinal axis I-I from the proximal end 3a of the first element 3 (FIGS. 12 and 13),
a ring 11 shaped to form a seat 20 for the first screw head 10a and to be mounted in said first element 3 by axial penetration along the first longitudinal axis I-I in the first passage section 4a from the proximal end 3a of said first element 3 (FIGS. 12 and 13) as far as a predetermined axial position (FIGS. 13 and 19) in which locking means 12 are able to oppose movement in translation of the ring 11 in the direction of the proximal end 3a of said first element 3.

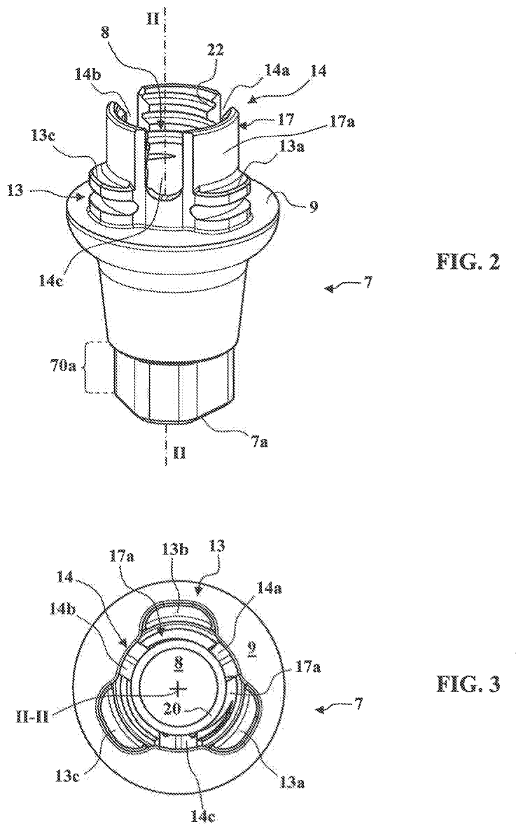

It is seen in FIGS. 1 and 2 that the second element 7 includes a proximal section 70a with a non-circular cross section (in this instance a triangular section with rounded vertices). The proximal section 70a is intended to be received in a distal section 29b of the interior housing 29 of the dental implant 2 (FIG. 21), which distal section 29b also has a complementary non-circular cross section so as to obtain indexing in rotation of the second element 7 and of the dental implant 2 around the second longitudinal axis II-II.

The second element 7 includes at least a second rotation indexing member 13 and a third rotation indexing member 14.

The ring 11 includes at least one fourth rotation indexing member 15.

The third rotation indexing member 14 and the fourth rotation indexing member 15 are shaped to interlock with one another by axial inter-penetration along the second longitudinal axis II-II when the second element 7 and the ring 11 are in a penetration orientation (FIG. 15) relative to one another about the second longitudinal axis II-II so that in an interlocked position the third rotation indexing member 14 and the fourth rotation indexing member 15 block rotation of the ring 11 relative to the second element 7 about the second longitudinal axis II-II.

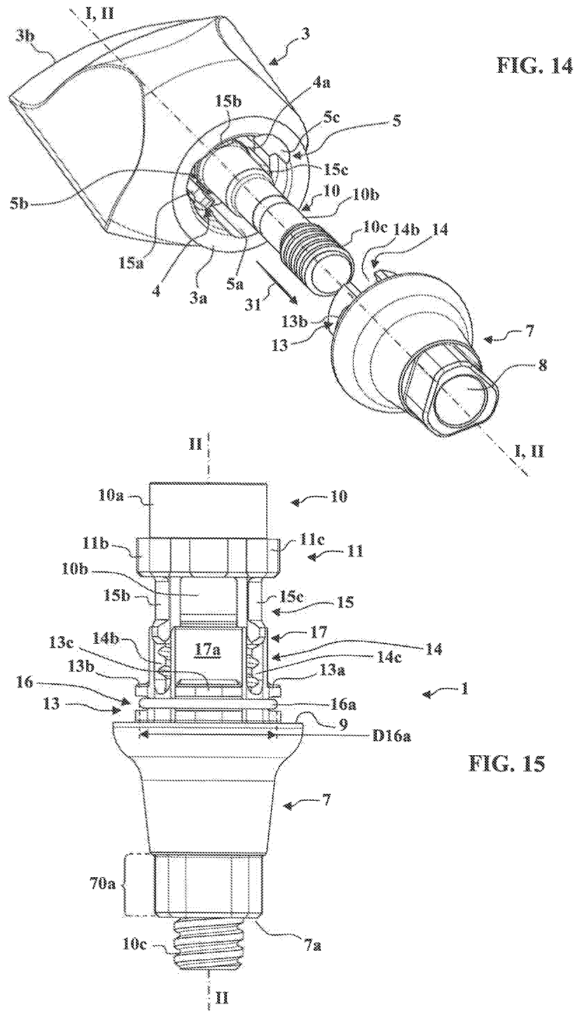

The first rotation indexing member 5 and the second rotation indexing member 13 are shaped to interlock with one another by axial inter-penetration along the second longitudinal axis II-II when said first element 3 and the second element 7 are in a penetration orientation (FIG. 14) relative to one another about the second longitudinal axis II-II so that in an interlocked position (FIG. 19) the first rotation indexing member 5 and the second rotation indexing member 13 block rotation of said first element 3 relative to the second element 7 around the second longitudinal axis II-II.

In its predetermined axial position the ring 11 can be pivoted about the first longitudinal axis I-I as far as a locking orientation (FIG. 13) in which the first axial retaining member 6 opposes movement in translation of the ring 11 in the direction of the proximal end 3a of said first element 3.

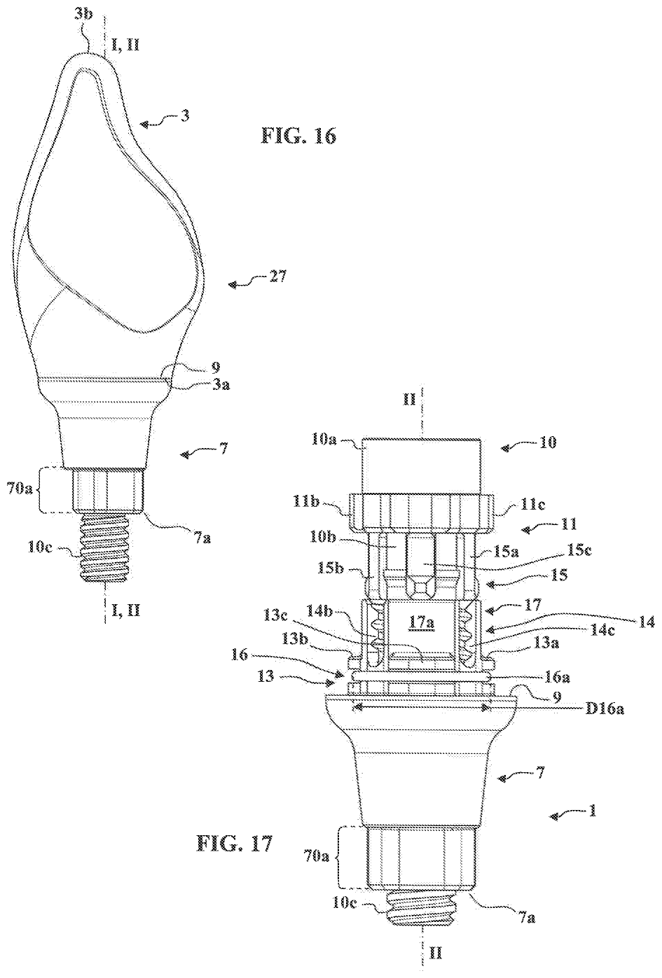

As can be seen in FIG. 14, when the ring 11 is in said at least one locking angular orientation (FIGS. 14 and 15) the first indexing member 5, the second indexing member 13, the third indexing member 14 and the fourth indexing member 15 interlock (the first indexing member 5 and the second indexing member 13 on the one hand and the third indexing member 14 and the fourth indexing member 15 on the other hand) to allow the bearing surface 9 of the second element 7 to come to bear axially against the proximal end 3a of said first element 3 (FIG. 16).

Conversely, when the ring 11 is not in said at least one locking angular orientation the first indexing member 5, the second indexing member 13, the third indexing member 14 and the fourth indexing member 15 form axial abutments preventing the bearing surface 9 of the second element 7 from coming to bear axially against the proximal end 3a of said first element 3. Two situations can then arise:
if the second element 7 and the ring 11 are in their penetration orientation (FIG. 15) relative to one another about the second longitudinal axis II-II the first indexing member 5 and the second indexing member 13 form axial abutments preventing the bearing surface 9 of the second element 7 from coming to bear axially against the proximal end 3a of said first element 3;
if the first element 3 and the second element 7 are in a penetration orientation (FIG. 14) relative to one another about the second longitudinal axis II-II the third indexing member 14 and the fourth indexing member 15 form axial abutments (FIG. 17) preventing the bearing surface 9 of the second element 7 from coming to bear axially against the proximal end 3a of said first element 3.

First friction means 16 enable a friction fit of the second element 7 in said first element 3 slowing movement in translation of the second element 7 away from said first element 3 along the first longitudinal axis I-I. In this instance the first friction means 16 comprise an elastic ring 16a with a radial slot the outside diameter D16a (FIG. 15) of which is greater than an inside diameter D4a of the first passage section 4a (FIG. 10). When the second element 7 is engaged in said first element 3 the elastic ring 16a is compressed radially (thanks to its radial slot) to penetrate into the first passage section 4a.

It is seen in FIG. 1 that the first fastening screw 10 includes an annular rib 10d with outside diameter D10d slightly greater than the inside diameter D11a of the ring 11 (FIG. 5). The ring 11 can therefore be mounted captive on the shank 10b of the first screw 10 between the first screw head 10a and the annular rib 10d.

It is seen more particularly in FIGS. 1 to 6 that the third rotation indexing member 14 and the fourth rotation indexing member 15 comprise:
on the ring 11, three longitudinal fins 15a to 15c,
on the second element 7, a cylindrical section 17 with a tubular lateral wall 17a in which are formed three longitudinal slots 14a to 14c adapted to receive said longitudinal fins 15a to 15c.

It is also seen in FIGS. 2 and 3 that said at least one second rotation indexing member 13 comprises three radial projections 13a to 13c at the periphery of the cylindrical section 17 of the second element 7, said radial projections 13a to 13c being adapted to be engaged in the first rotation indexing member 5, which is itself in the form of three longitudinal grooves 5a to 5c formed in the lateral wall of the first passage section 4a of said first element 3 when the bearing surface 9 of the second element 7 receives in axial bearing engagement the proximal end 3a of said first element 3.

The radial projections 13a to 13c and the longitudinal slots 14a to 14c on the second element 7 are offset angularly relative to one another about the second longitudinal axis II-II.

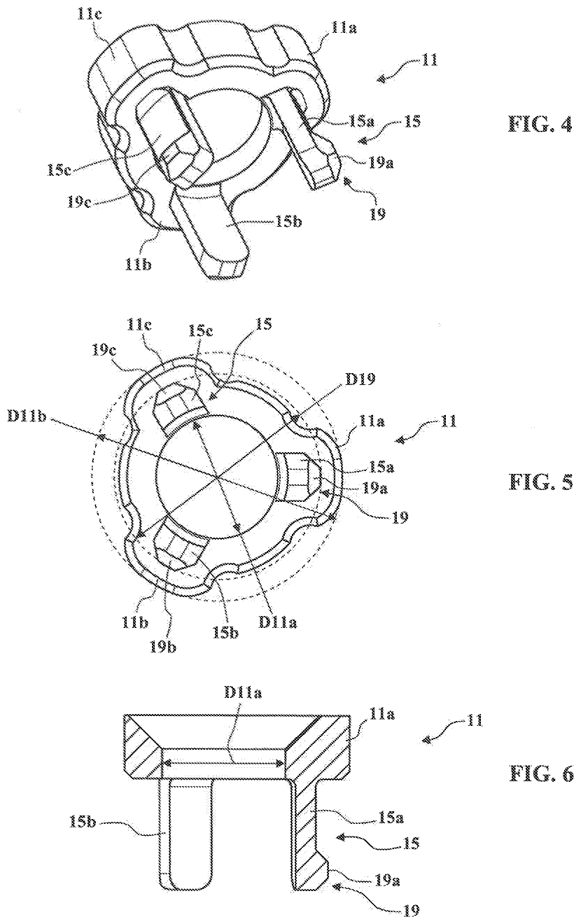

It can be seen more particularly in FIGS. 4 and 5 that:
the ring 11 comprises three radial protrusions 11a to 11c on its periphery, said radial protrusions 11a to 11c being adapted to bear against the first axial retaining member 6, which is itself in the form of a shoulder 6a in the first passage section 4a of said first element 3 when the ring 11 is in the locking orientation (FIG. 19),
said radial protrusions 11a to 11c are shaped to be able to slide axially in said longitudinal grooves 5a to 5c during axial penetration of the ring 11 into the first passage section 4a of said first element 3.

The radial protrusions 11a to 11c confer an outside diameter D11b on the ring 11.

The ring 11 includes second friction means 19 which are adapted, when the ring 11 is in the locking orientation, to slow rotation of the ring 11 relative to the first element 3 about the first longitudinal axis I-I. In this instance the free ends of the longitudinal fins 15a to 15c include radial bosses 19a to 19c defining an outside diameter D19 greater than the inside diameter D4a of the first passage section 4a. When the ring 11 is pivoted toward a locking orientation the longitudinal fins 15a to 15c are therefore flexed slightly in the radial direction toward the center of the ring 11 and the radial bosses 19a to 19c bear against the lateral wall of the first passage section 4a.

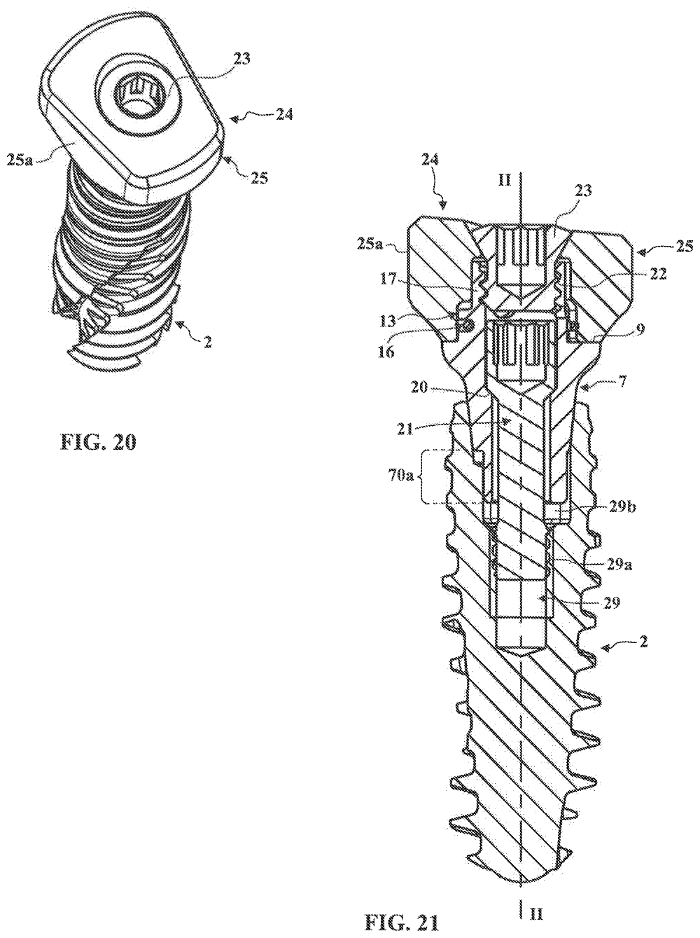

It is seen more particularly in FIG. 1 that the second through-passage 8 of the second element 7 includes:
a seat 20 for the head of a second screw 21 (FIGS. 21 and 23) adapted to pass through the second element 7 and to be received in the second through-passage 8 in order to be screwed into the dental implant 2,
a distal internal thread 22 adapted to receive a third screw 23 enabling fixing onto the second element 7 of a temporary through-fixed element 24 (FIGS. 20 to 23).

The temporary through-fixed element 24 from FIGS. 20 and 21 is a healing part 25 the lateral wall 25a of which is shaped so as to come at least in part in contact with the gum.

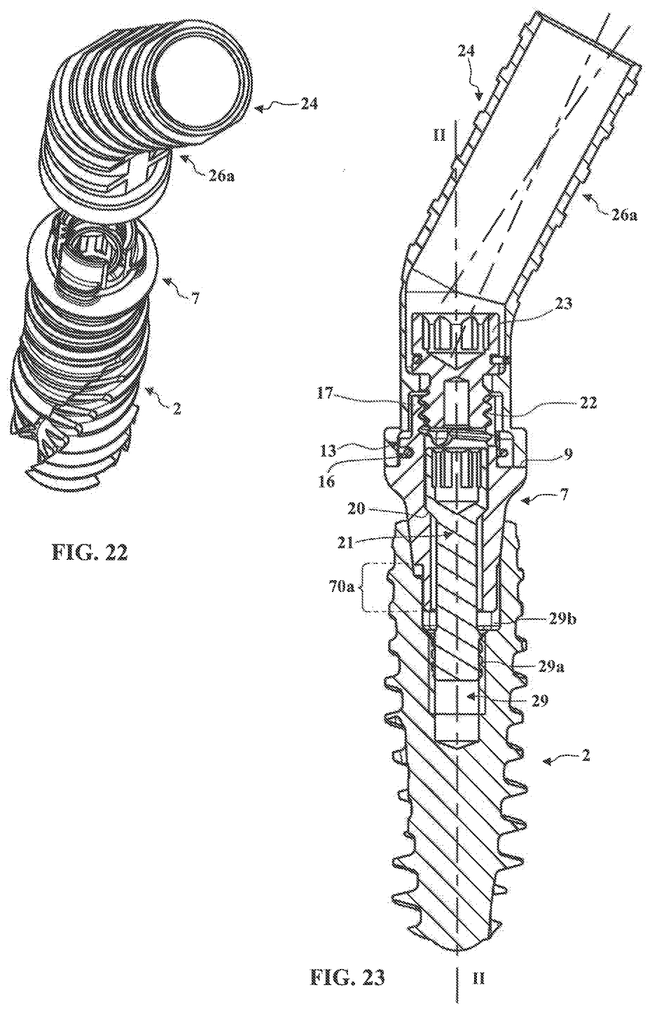

The temporary through-fixed element 24 from FIGS. 22 and 23 is an interior tube 26a on which it is intended to mount a commercially available standard prosthetic tooth to form a temporary dental prosthesis.

There may also be provided a temporary through-fixed element 24 of the impression-taking part type shaped to be scanned in the mouth and/or to be overmolded with an impression-taking compound.

The temporary through-fixed elements 24 are indexed in rotation on the second element 7 by means of longitudinal grooves that are similar to the longitudinal grooves 5a to 5c and cooperate in a similar way with the radial projections 13a to 13c of the second element 7.

The first element 3 intended to cooperate with the dental sub-assembly 1 is more particularly shown in detail in FIGS. 7 to 11.

The first element 3 is a dental element for individual prosthetic restoration of a tooth of core type on which stratification is performed or of ceramic core type. The assembly of the first element 3 with the dental sub-assembly 1 enables first element 3 to be mounted on and fixed to the dental implant 2.

As already indicated the first element 3 includes a first through-passage 4 including a first passage section 4a extending from the proximal end 3a of said first element 3 along a first longitudinal axis I-I. The first element 3 also includes a first axial retaining member 6.

The first element 3 includes at least one first rotation indexing member 5 comprising the three longitudinal grooves 5a to 5c.

The first rotation indexing member 5 and the second rotation indexing member 13 are shaped to interlock with one another by axial inter-penetration along the second longitudinal axis II-II when said first element 3 and the second element 7 are in a penetration orientation relative to one another about the second longitudinal axis II-II (FIG. 14). In the interlocked position the first rotation indexing member 5 and the second rotation indexing member 13 block rotation of said first element 3 relative to the second element 7 about the second longitudinal axis II-II.

The first passage section 4a of said first element 3 is shaped so that in its predetermined axial position the ring 11 can be pivoted about the first longitudinal axis I-I as far as a locking orientation (FIG. 13) in which the first axial retaining member 6 opposes movement in translation of the ring 11 in the direction of the proximal end 3a of said first element 3.

In this instance the first passage section 4a includes an annular housing 28 with inside diameter D28 slightly greater than the outside diameter D11b of the ring 11.

The first axial retaining member 6 is in the form a shoulder 6a in the first passage section 4a of said first element 3 (FIG. 11). The ring 11 comprises radial protuberances 11a to 11c on its periphery, said radial protuberances 11a to 11c being adapted to bear against the shoulder 6a when the ring 11 is in the locking orientation.

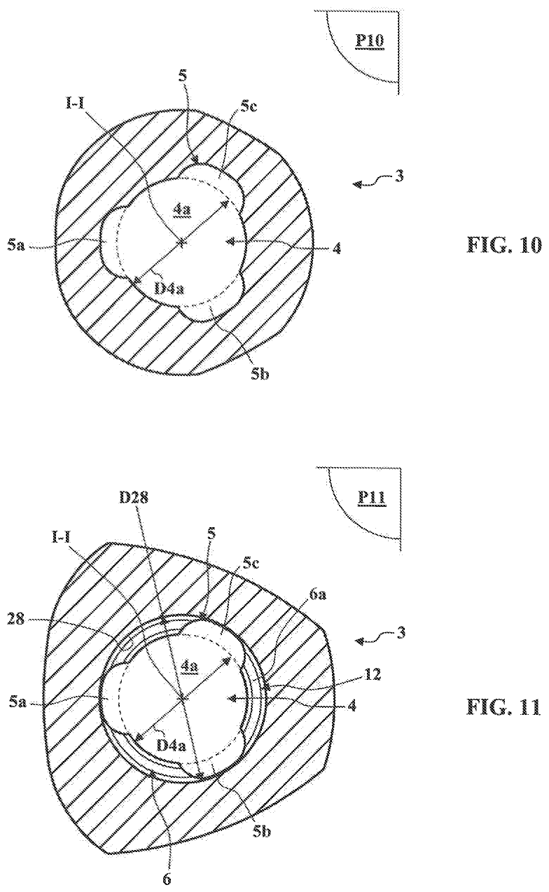

It is seen more particularly in FIG. 9 that the first through-passage 4 further includes a second passage section 4b extending substantially along a third longitudinal axis III-III. Said second passage section 4b obliquely extends the first passage section 4a so that the first passage section 4a and the second passage section 4b form between them a substantially non-zero angle A. The angle A enables the second passage section 4b to open away from the active parts (cuspids or free edge 3b) of the first element 3.

When assembled, the dental sub-assembly 1 and the first element 3 form a dental component 27 as depicted in FIG. 16.

Using the dental sub-assembly 1 to fix the first element 3 onto the dental implant 2 will be explained hereinafter with the aid of FIGS. 12 to 19.

During a first surgery visit the practitioner installs the dental implant 2 in the mouth of the patient, in the maxillary or mandibular bone of the patient. The practitioner also installs the second element 7 on the dental implant 2, causing its proximal end 7a to penetrate into the interior housing 29 (FIG. 21). The proximal section 70a of the second element 7 and the distal section 29b of the interior housing 29 cooperate to index the second element 7 and the dental implant 2 in rotation relative to one another around the second longitudinal axis II-II. The first element 3 is retained on the dental implant 2 by the second screw 21 that comes to be engaged in an internally-threaded section 29a and bears against the seat 20.

A first possibility is for the practitioner then to mount a healing part 25 on and fix it to the second element 7 by means of a third screw 23 that is screwed into the distal internal thread 22 that is formed in the cylindrical section 17. The healing part 25 is also indexed in rotation on the second element 7 (by means of the radial projections 13a to 13c of the latter) and is intended to remain in place during a time of osteo-integration of the dental implant 2 in the maxillary or mandibular bone and of healing of the gum around the first element 3. There is then created attachment of the gum at the periphery of the second element 7, which is important for the long-term preservation of the bone at the periphery of the dental implant 2.

After healing an impression may be produced using an intra-oral scanner thereafter to enable the bespoke production of the first element 3, for example by computer-assisted design and manufacture. During this design and manufacture the second through-passage section 4b is disposed obliquely relative to the first through-passage section 4a (substantially at the angle A) so as to cause the second passage section 4b to open away from the active parts (cuspids or free edge 3b) of the first element 3.

As an alternative to an intra-oral scanner, there may be recourse to an impression-taking part intended to be overmolded in an impression-taking compound that is mounted on and fixed temporarily to the first element 3 instead and in place of the healing part 25.

According to another possibility, if the conditions of stability of the dental implant 2 are sufficient when first fitted, a temporary dental prosthesis may be produced and fixed immediately including an interior tube 26a onto which is mounted and fixed a commercially available standard tooth prosthesis (made of plastic material for example).

By means of the interior tube 26a the temporary dental prosthesis is also indexed in rotation on the second element 7 (thanks to the radial projections 13a to 13c of the latter) and is intended to remain in place during a time of osteo-integration of the dental implant 2 in the maxillary or mandibular bone and of healing of the gum around the first element 3. An attachment of the gum is then created at the periphery of the second element 7, which is important for the long-term preservation of the bone at the periphery of the dental implant 2.

Once the first element 3 (depicted in FIGS. 7 to 11) has been manufactured there follows a second surgery visit during which the practitioner mounts the first element 3 on and fixes it to the dental implant 2 by means of the sub-assembly 1 according to the present invention.

The practitioner starts by removing the third screw 23, the second screw 21 and the healing element 25.

The practitioner then takes up the first fastening screw 10 and inserts it into the ring 11 until the latter is disposed between the first screw head 10a and the annular ring 10d. The ring 11 is then captive on the first fastening screw 10.

The radial protrusions 11a to 11c on the ring 11 are disposed in corresponding relationship with the longitudinal grooves 5a to 5c of the first rotation indexing member 5 (FIG. 12), after which the practitioner then inserts the ring 11 and the first screw head 10a into the first passage section 4a by means of a movement in axial translation along the first longitudinal axis I-I from the first proximal end 3a of the first element 3 until the ring 11 reaches the predetermined axial position (this movement is schematically represented by the arrow 30 in FIG. 12).

During this movement the radial protrusions 11a to 11c slide in the longitudinal grooves 5a to 5c. At the end of penetration the ring 11 is engaged in the annular housing 28 in the predetermined axial position, being disposed axially beyond the shoulder 6a along the first longitudinal axis I-I.

The practitioner turns the ring 11 about the first longitudinal axis I-I (for example by one sixth of a turn) to reach the configuration depicted in FIG. 13 in which the radial protrusions 11a to 11c are no longer in corresponding relationship with the longitudinal grooves 5a to 5c but in corresponding relationship with the shoulder 6a of the first axial retaining member 6. The ring 11 is then in an (angular) locking orientation in which locking means 12 (comprising the radial protrusions 11a to 11c and the shoulder 6a) oppose movement in translation of the ring 11 in the direction of the proximal end 3a of the first element 3. In other words, the ring 11 is mounted on and fixed axially in the first passage section 4a to constitute a screw seat for the first fastening screw 10, which is therefore captive in the first element 3. There is then arrived at a preliminary assembly consisting of the first element 3, the ring 11 and the first fastening screw 10.

When the ring 11 is pivoted into the locking orientation the radial bosses 19a to 19c of the second friction means 19 come to rub and bear on the lateral wall part of the first passage section 4a having an inside diameter D4a slightly less than the outside diameter D19. The second friction means 19 limit the risks of the ring 11 accidentally pivoting so that the radial protrusions 11a to 11c return into corresponding relationship with the longitudinal grooves 5a to 5c.

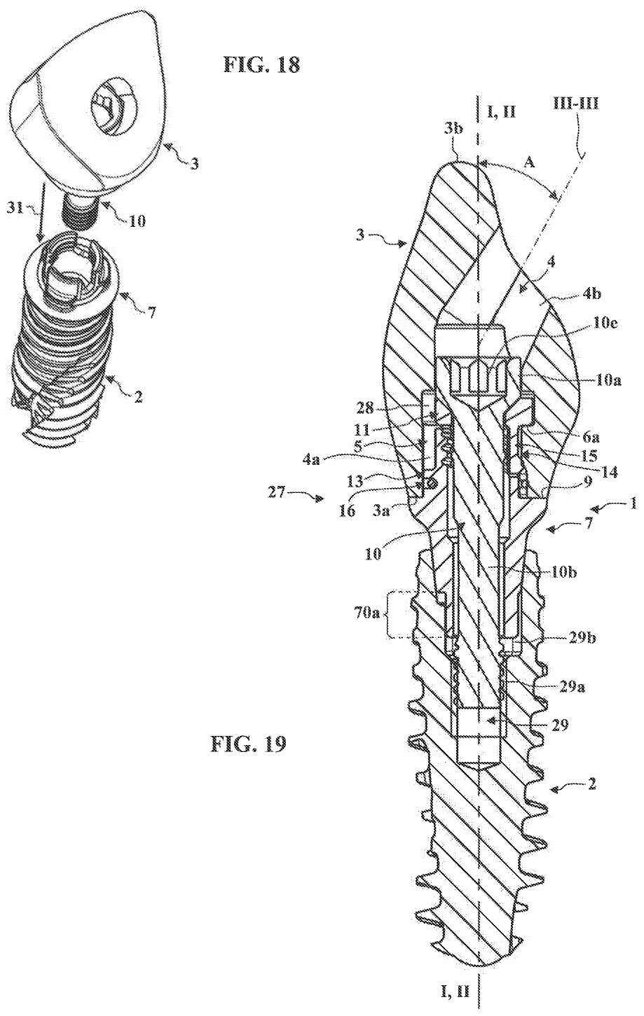

In a subsequent step the practitioner mounts the preliminary assembly from FIG. 13 (first element 3, first fastening screw 10 and ring 11) on the second element 7 (which is in the mouth of the patient, engaged on the dental implant 2) as depicted in FIGS. 14 and 18 to form a dental component 27 comprising the first element 3, the first fastening screw 10, the ring 11 and the second element FIG. 7 (FIG. 16).

To this end the longitudinal grooves 5a to 5c of the first rotation indexing member 5 are placed in corresponding relationship to the radial projections 13a to 13c of the second rotation indexing member 13 about the first longitudinal axis I-I (which then coincides with the second longitudinal axis II-II). At the same time the longitudinal slots 14a to 14c of the third rotation indexing member 14 are automatically in corresponding relationship to the longitudinal fins 15a to 15c of the fourth rotation indexing member 15. The practitioner then drives the first element 3 onto the second element 7 (this movement is depicted by the arrow 31) until the proximal end 3a of the first element 3 is brought to bear against the bearing surface 9 of the second element 7. During this movement:
the longitudinal slots 14a to 14c and the longitudinal fins 15a to 15c interlock by axial inter-penetration (FIG. 15),
the longitudinal grooves 5a to 5c and the radial projections 13a to 13c interlock by axial inter-penetration,
the first friction means 16 (elastic ring 16a) come to rub against the lateral wall part of the first passage section 4a having an inside diameter D4a slightly less than the outside diameter D16a.

If the ring 11 were not in the locking angular orientation the first rotation indexing number 5, the second rotation indexing member 13, the third rotation indexing member 14 and the fourth rotation indexing member 15 would form axial abutments preventing the bearing surface 9 of the second element 7 from coming to bear axially against the proximal end 3a of said first element 3. To be more precise, two situations can arise:
either the second element 7 and the ring 11 are in their penetration orientation (FIG. 15) relative to one another about the second longitudinal axis II-II, in which case the first rotation indexing member 5 and the second rotation indexing member 13 form axial abutments preventing the bearing surface 9 of the second element 7 from coming to bear axially against the proximal end 3a of said first element 3;
or the first element 3 and the second element 7 are in a penetration orientation (FIG. 14) relative to one another about the second longitudinal axis II-II, in which case the third rotation indexing member 14 and the fourth rotation indexing member 15 form axial abutments (FIG. 17) preventing the bearing surface 9 of the second element 7 from coming to bear axially against the proximal end 3a of said first element 3.

It is therefore seen that, if it is possible to bring the bearing surface 9 of the second element 7 to bear against the proximal end 3a of the first element 3, it is because the ring 11 is necessarily in the locking orientation and can therefore reliably serve as a seat 20 for the first fastening screw 10.

Moreover, after the bearing surface 9 of the second element 7 is brought to bear against the proximal end 3a of the first element 3:
the first rotation indexing member 5 and the second rotation indexing member 13 are in an interlocked position in which they block rotation of said first element 3 relative to the second element 7 about the second longitudinal axis II-II;
the third rotation indexing member 14 and the fourth rotation indexing member 15 are in an interlocked position in which they block rotation of the ring 11 relative to the second element 7 about the second longitudinal axis II-II.

Moreover, the first friction means 16 (elastic ring 16a) oppose movement of the second element 7 away from said first element 3 along the first longitudinal axis I-I.

The overall result of this is that the ring 11 is immobilized in the locking orientation relative to the first element 3 after assembly of the dental component 27.

Once the dental component 27 has been assembled, the practitioner then proceeds to screw the first fastening screw 10 into the internally threaded section 29a by means of a screwdriving tool (as described for example in the document EP 2 607 722 A1) engaged through the second passage section 4b: the screwdriving head of the screwdriving tool comes to be engaged in the six-sided female impression 10e of the first screw head 10a. Bearing on the ring 11 forming a seat, the first screw head 10a holds the first element 3 and the second element 7 onto the dental implant 2. The configuration is then that depicted in FIG. 19.

The non-zero angle A enables the second passage section 4b to open away from the active parts (cuspids or free edge 3b) of the first element 3. It is nevertheless possible to have recourse to a first passage section 4a aligned with a second passage section 4b (zero angle A) in the absence of conflict with active parts (cuspids or free edge 3b) of the first element 3.

Whether the angle A is zero or not, engagement of the first screw head 10a and the ring 11 by the proximal end of the first element enables the second passage section 4b to have a cross section that is only sufficient to ensure access of the screwdriving tool to the first screw head 10a (and thus a cross section smaller than would be needed to pass the screw along a possibly curvilinear path if the angle A were non-zero, through the first element 3 from the second passage section 4b to the first passage section 4a), and the first element 3 is therefore stronger and less at risk of its color being affected by parts rendered translucent by small thicknesses of material.

If maintenance of the first element 3 is required subsequently, the practitioner proceeds to unscrew the first fastening screw 10 and withdraws the first element 3, the ring 11 and the first fastening screw 10. The second element 7 may remain in the mouth of the patient (so as not to break unnecessarily the attachment of the gums all around it), covering it with a healing part 25 as in FIG. 21.

Mounting the first element 3 on a second element 7 already in the mouth of a patient and fixing it thereto in order to favor healing of the gum around said second element 7 has already been described. The dental component 27 is then assembled in-vivo.

It is nevertheless feasible to perform the healing phase by means of a part distinct from the second element 7. In this case the dental practitioner may be supplied with a dental component 27 as depicted in FIG. 16 previously assembled ex-vivo by an assembly process comprising the following steps:
a) inserting the shank 10b of the first screw 10 in the ring 11,
b) inserting in the first passage section 4a the ring 11 and the first screw head 10a by movement in axial translation along the first longitudinal axis I-I from the proximal end 3a of the first element 3 so as to cause the ring 11 to reach the predetermined axial position,
c) causing the ring 11 to pivot about the first longitudinal axis I-I to bring it into the locking orientation,
d) mounting the second element 7 on the proximal end 3a of the first element 3 by engaging the shank 10b of the first screw in the second through-passage 8 until the bearing surface 9 of the second element 7 is brought to bear against the proximal end 3a of the first element 3.

When they receive the dental component 27 the practitioner has only to install it on the dental implant 2 and to screw it on to fix it thereto.

One aspect of the present invention concerns the objects defined by the following clauses:

A—dental sub-assembly (1) for the individual prosthetic restoration of a tooth, shaped to be received on a dental implant (2), said dental sub-assembly (1) being adapted to be assembled with a first element (3) of core type on which stratification is performed or of ceramic core type, said first element (3) having a first through-passage (4) including a first passage section (4a) extending from a proximal end (3a) of said first element (3) along a first longitudinal axis (I-I), said first element (3) including at least a first rotation indexing member (5) and a first axial retaining member (6), said dental sub-assembly (1) including:
a second element (7) with a second through-passage (8) extending along a second longitudinal axis (II-II), including a bearing surface (9) shaped to be able to receive in axial bearing engagement the proximal end (3a) of said first element (3) and including a proximal end (7a) shaped to be able to come to bear axially against or shaped to be able to come to penetrate into said dental implant (2),
a first fastening screw (10) including a first screw head (10a) from which extends a first screw shank (10b) adapted to pass through the second element (7), being received in the second through-passage (8) and having an externally-threaded section (10c) shaped to be received by screwing in said dental implant (2), the first screw head (10a) being sized so as to enable it to be received by axial penetration in the first passage section (4a) along the first longitudinal axis (I-I) from the proximal end (3a) of the first element (3),
a ring (11) shaped to form a seat for the first screw head (10a) and to be mounted on said first element (3) by axial penetration along the first longitudinal axis (I-I) in the first passage section (4a) from the proximal end (3a) of said first element (3) as far as a predetermined axial position in which locking means (12) are able to oppose movement in translation of the ring (11) in the direction of the proximal end (3a) of said first element (3),

in which:
said second element (7) includes at least a second rotation indexing member (13) and a third rotation indexing member (14),
the ring (11) includes at least one fourth rotation indexing member (15),
the third rotation indexing member (14) and the fourth rotation indexing member (15) are shaped to interlock by axial inter-penetration along the second longitudinal axis (II-II) when the second element (7) and the ring (11) are in a penetration orientation relative to one another about the second longitudinal axis (II-II) so that in an interlocked position the third rotation indexing member (14) and the fourth rotation indexing member (15) block rotation of the ring (11) relative to the second element (7) about the second longitudinal axis (II-II),
the first rotation indexing member (5) and the second rotation indexing member (13) are shaped to interlock by axial inter-penetration along the second longitudinal axis (II-II) when said first element (3) and the second element (7) are in a penetration orientation relative to one another about the second longitudinal axis (II-II) so that in an interlocked position the first rotation indexing member (5) and the second rotation indexing member (13) block rotation of said first element (3) relative to the second element (7) about the second longitudinal axis (II-II),
in its predetermined axial position the ring (11) can be pivoted about the first longitudinal axis (I-I) into a locking orientation in which the first axial retaining member (6) opposes movement in translation of the ring (11) in the direction of the proximal end (3a) of said first element (3).

B—Dental sub-assembly (1) according to clause A in which when the ring (11) is not in said at least one locking angular orientation the first indexing member (5), the second indexing member (13), the third indexing member (14) and the fourth indexing member (15) form axial abutments preventing the bearing surface (9) of the second element (7) from coming to bear axially against the proximal end (3a) of said first element (3).

C—Dental sub-assembly (1) according either one of clauses A or B in which first friction means (16) enable a friction fit of the second element (7) in said first element (3) slowing movement in translation of the second element (7) away from said first element (3) along the first longitudinal axis (I-I).

D—Dental sub-assembly (1) according to any one of clauses A to C in which the ring (11) is captive on the shank (10b) of the first screw.

E—Dental sub-assembly (1) according to any one of clauses A to D in which the third rotation indexing member (14) and the fourth rotation indexing member (15) comprise:
on one of the ring (11) or the second element (7) at least one longitudinal fin (15a-15c),
on the other of the ring (11) or the second element (7) a cylindrical section (17) with a tubular lateral wall (17a) including at least one longitudinal slot (14a-14c) adapted to receive said at least one longitudinal fin (15a-15c).

F—Dental sub-assembly (1) according to clause E in which said at least one second rotation indexing member (13) comprises a radial projection (13a-13c) at the periphery of a cylindrical section (17) of the second element (7), said radial projection (13a-13c) being adapted to be engaged in the first rotation indexing member (5) which is itself in the form of a longitudinal groove (5a-5c) formed in the lateral wall of the first passage section (4a) of said first element (3) when the bearing surface (9) of the second element (7) receives in axial bearing engagement the proximal end (3a) of said first element (3).

G—Dental sub-assembly (1) according to clause F, in which:
the ring (11) includes a radial protuberance (11a-11c) at the periphery of the ring (11), said radial protuberance (11a-11c) being adapted to bear against the first axial retaining member (6) which is itself in the form of a shoulder (6a) in the first passage section (4a) of said first element (3) when the ring (11) is in the locking orientation,
said radial protuberance (11a-11c) is shaped to be able to slide axially in said longitudinal groove (5a-5c) during axial penetration of the ring (11) into the first passage section (4a) of said first element (3).

H—Dental sub-assembly (1) according to any one of clauses E to G in which on said second element (7) said radial projection (13a 13c) and said longitudinal slot (14a-14c) or longitudinal fin (15a-15c) are offset angularly relative to one another about the second longitudinal axis (II-II).

I—Dental sub-assembly (1) according to any one of clauses A to H in which the ring (11) includes second friction means (19) which are adapted, when the ring (11) is in the locking orientation, to slow rotation of the ring (11) relative to the first element (3) about the first longitudinal axis (I-I).

J—Dental sub-assembly (1) according to any one of clauses A to I in which the second through-passage (8) of the second element (7) includes:
a seat (20) for the head of a second screw (21) adapted to pass through the second element (7), being received in the second through-passage (8) to be screwed into the dental implant (2),
a distal internal thread (22) adapted to receive a third screw (23) enabling fixing to the second element (7) of a temporary through-fixed element (24).

K—Dental sub-assembly (1) according to clause J comprising at least one temporary through-fixed element (24), namely:
a healing part (25) the lateral wall (25a) of which is shaped to come at least in part into contact with the gum, and/or
an impression-taking part shaped to be scanned intra-orally and/or overmolded in an impression-taking compound, and/or
a temporary dental prosthesis.

L—Dental sub-assembly (1) according to either one of clauses J or K in which the temporary through-fixed element (24) is indexed in rotation on the second element (7).

M—First element (3) for the individual prosthetic restoration of a tooth of core type on which stratification is performed or of ceramic core type, said first element (3) including a first through-passage (4) including a first passage section (4a) extending from a proximal end (3a) of said first element (3) along a first longitudinal axis (I-I), said first element (3) including a first axial retaining member (6),
a dental sub-assembly (1) onto which said first element (3) can be assembled, said dental sub-assembly (1) being itself shaped to be received on a dental implant (2) and including:
a second element (7) including a second through-passage (8) extending along a second longitudinal axis (II-II), including a bearing surface (9) shaped to be able to receive in axial bearing engagement the proximal end (3a) of said first element (3) and having a proximal end (7a) shaped to be able to come to bear axially against or shaped to be able to come to penetrate into said dental implant (2),
a first fastening screw (10) including a first screw head (10a) from which extends a first screw shank (10b) adapted to pass through the second element (7), being received in the second through-passage (8) and having an externally-threaded section (10c) shaped to be received by screwing in said dental implant (2), the first passage section (4a) of the first element (3) being sized so as to enable the reception of the first screw head (10a) by axial penetration along the first longitudinal axis (I-I) from the proximal end (3a) of the first element (3),
a ring (11) shaped to form a seat for the first screw head (10a) and to be mounted in said first element (3) by axial penetration along the first longitudinal axis (I-I) in the first passage section (4a) from the proximal end (3a) of said first element (3) to a predetermined axial position in which locking means (12) are able to oppose movement in translation of the ring (11) in the direction of the proximal end (3a) of said first element (3),
said second element (7) including at least a second rotation indexing member (13) and a third rotation indexing member (14),
the ring (11) including at least one fourth rotation indexing member (15),
the third rotation indexing member (14) and the fourth rotation indexing member (15) being shaped to interlock by axial inter-penetration along the second longitudinal axis (II-II) when the second element (7) and the ring (11) are in a penetration orientation relative to one another about the second longitudinal axis (II-II) so that in an interlocked position the third rotation indexing member (14) and the fourth rotation indexing member (15) block rotation of the ring (11) relative to the second element (7) about the second longitudinal axis (II-II), in which:
said first element (3) includes at least one first rotation indexing member (5),
the first rotation indexing member (5) and the second rotation indexing member (13) are shaped to interlock by axial inter-penetration along the second longitudinal axis (II-II) when said first element (3) and the second element (7) are in a penetration orientation relative to one another about the second longitudinal axis (II-II) so that in an interlocked position the first rotation indexing member (5) and the second rotation indexing member (13) block rotation of said first element (3) relative to the second element (7) about the second longitudinal axis (II-II),
the first passage section (4a) of said first element (3) is shaped so that in its predetermined axial position the ring (11) can be pivoted about the first longitudinal axis (I-I) into a locking orientation in which the first axial retaining member (6) opposes movement in translation of the ring (11) in the direction of the proximal end (3a) of said first element (3).

N—First element (3) according to clause M in which, when the ring (11) is not in said at least one locking angular orientation the first indexing member (5), the second indexing member (13), the third indexing member (14) and the fourth indexing member (15) form axial abutments preventing the bearing surface (9) of the second element (7) from coming to bear axially against the proximal end (3a) of said first element (3).

O—First element (3) according to either one of clauses M or N in which first friction means (16) enable a friction fit of the second element (7) in said first element (3) slowing movement in translation of the second element (7) away from said first element (3) along the first longitudinal axis (I-I).

P—First element (3) according to any one of clauses M to O in which said first rotation indexing member (5) is in the form of a longitudinal groove (5a-5c) formed in the lateral wall of the first passage section (4a) of said first element (3) and in which a radial projection (13a-13c) forming the second rotation indexing member (13) of the second element (7) can be engaged when the bearing surface (9) of the second element (7) receives in axial bearing engagement the proximal end (3a) of said first element (3).

Q—First element (3) according to any one of clauses M to P in which:
the first axial retaining member (6) is in the form of a shoulder (6a) in the first passage section (4a) of said first element (3),
the ring (11) includes a radial protuberance (11a-11c) at the periphery of the ring (11), said radial protuberance (11a-11c) being adapted to bear against the shoulder (6a) when the ring (11) is in the locking orientation.

R—First element (3) according to any one of clauses M to Q in which the first through-passage (4) further includes a second passage section (4b), said second passage section (4b) obliquely extending the first passage section (4a) so that the first passage section (4a) and the second passage section (4b) form a non-zero angle (A) between them.

S—Dental component (27) comprising a dental sub-assembly (1) according to any one of clauses A to L and a first element (3) according to any one of clauses M to R.

T—Method for ex-vivo assembly of a dental component (27) according to clause S comprising the following steps:
a) inserting the shank (10b) of the first screw (10) in the ring (11),
b) inserting the ring (11) and the first screw head (10a) in the first passage section (4a) by axial movement in translation along the first longitudinal axis (I-I) from the proximal end (3a) of the first element (3) so as to cause the ring (11) to reach the predetermined axial position,
c) causing the ring (11) to pivot about the first longitudinal axis (I-I) to bring it into the locking orientation,
d) mounting the second element (7) on the proximal end (3a) of the first element (3) by engaging the first screw shank (10b) in the second through-passage (8) until the bearing surface (9) of the second element (7) is brought to bear against the proximal end (3a) of the first element (3).

The present invention is not limited to the embodiments that have been described explicitly but includes the diverse variants and generalisations thereof contained within the scope of the following claims.

1-17. (canceled)

18. A dental sub-assembly for the individual prosthetic restoration of a tooth, shaped to be received on a dental implant, said dental sub-assembly being adapted to be assembled with a first element of core type on which stratification is performed or of ceramic core type, said dental sub-assembly including:
a second element with a second through-passage extending along a second longitudinal axis (II-II), including a bearing surface shaped to be able to receive in axial bearing engagement said first element and including a proximal end shaped to be able to come to bear axially against or shaped to be able to come to penetrate into said dental implant,
a first fastening screw including a first screw head from which extends a first screw shank adapted to pass through the second element, being received in the second through-passage and having an externally-threaded section shaped to be received by screwing in said dental implant, the first screw head being sized so as to enable it to be received in said first element,
a ring shaped to form a seat for the first screw head and shaped to be mounted on and retained in said first element,
wherein:
said second element includes at least one second rotation indexing member shaped to block rotation of said first element relative to the second element about the second longitudinal axis (II-II) and includes a third rotation indexing member,
the ring includes at least one fourth rotation indexing member,
the third rotation indexing member and the fourth rotation indexing member are shaped to interlock by axial inter-penetration along the second longitudinal axis (II-II) when the second element and the ring are in a penetration orientation relative to one another about the second longitudinal axis (II-II) so that in an interlocked position the third rotation indexing member and the fourth rotation indexing member block rotation of the ring relative to the second element about the second longitudinal axis (II-II).

19. The dental sub-assembly as claimed in claim 18 wherein the ring is captive on the shank of the first screw.

20. The dental sub-assembly as claimed in claim 18 wherein the third rotation indexing member and the fourth rotation indexing member comprise:
on one of the ring or the second element at least one longitudinal fin,
on the other of the ring or the second element a cylindrical section with a tubular lateral wall including at least one longitudinal slot adapted to receive said at least one longitudinal fin.

21. The dental sub-assembly as claimed in claim 20 wherein said at least one second rotation indexing member comprises a radial projection at the periphery of a cylindrical section of the second element.

22. The dental sub-assembly as claimed in claim 21 wherein the ring comprises a radial protuberance at the periphery of the ring.

23. The dental sub-assembly as claimed in claim 20 wherein on said second element said radial projection and said longitudinal slot or longitudinal fin are offset angularly relative to one another about the second longitudinal axis (II-II).

24. The dental sub-assembly as claimed in claim 18 wherein the second through-passage of the second element includes:
a seat for the head of a second screw adapted to pass through the second element, being received in the second through-passage to be screwed into the dental implant,
a distal internal thread adapted to receive a third screw enabling fixing to the second element of a temporary through-fixed element.

25. The dental sub-assembly as claimed in claim 24 wherein it comprises at least one temporary through-fixed element, namely:
a healing part the lateral wall of which is shaped to come at least in part into contact with the gum, and/or
an impression-taking part shaped to be scanned intra-orally and/or overmolded in an impression-taking compound, and/or
a temporary dental prosthesis.

26. The dental sub-assembly as claimed in claim 24 wherein the temporary through-fixed element is indexed in rotation on the second element.

27. A central component including:
a first element for the individual prosthetic restoration of a tooth of core type on which stratification is performed or of ceramic core type, said first element including a first through-passage including a first passage section extending from a proximal end of said first element along a first longitudinal axis (I-I), said first element including a first axial retaining member,
a dental sub-assembly onto which said first element can be assembled, said dental sub-assembly being itself shaped to be received on a dental implant and including:
a. a second element including a second through-passage extending along a second longitudinal axis (II-II), including a bearing surface shaped to be able to receive in axial bearing engagement the proximal end of said first element and having a proximal end shaped to be able to come to bear axially against or shaped to be able to come to penetrate into said dental implant,
b. a first fastening screw including a first screw head from which extends a first screw shank adapted to pass through the second element, being received in the second through-passage and having an externally-threaded section shaped to be received by screwing in said dental implant, the first passage section of the first element being sized so as to enable the reception of the first screw head by axial penetration along the first longitudinal axis (I-I) from the proximal end of the first element,
c. a ring shaped to form a seat for the first screw head and to be mounted in said first element by axial penetration along the first longitudinal axis (I-I) in the first passage section from the proximal end of said first element to a predetermined axial position in which locking means are able to oppose movement in translation of the ring in the direction of the proximal end of said first element,
in which:
said second element includes at least a second rotation indexing member and a third rotation indexing member,
the ring includes at least one fourth rotation indexing member,
the third rotation indexing member and the fourth rotation indexing member are shaped to interlock by axial inter-penetration along the second longitudinal axis (II-II) when the second element and the ring are in a penetration orientation relative to one another about the second longitudinal axis (II-II) so that in an interlocked position the third rotation indexing member and the fourth rotation indexing member block rotation of the ring relative to the second element about the second longitudinal axis (II-II),
said first element includes at least one first rotation indexing member,
the first rotation indexing member and the second rotation indexing member are shaped to interlock by axial inter-penetration along the second longitudinal axis (II-II) when said first element and the second element are in a penetration orientation relative to one another about the second longitudinal axis (II-II) so that in an interlocked position the first rotation indexing member and the second rotation indexing member block rotation of said first element relative to the second element about the second longitudinal axis (II-II),
the first passage section of said first element is shaped so that in its predetermined axial position the ring can be pivoted about the first longitudinal axis (I-I) into a locking orientation in which the first axial retaining member opposes movement in translation of the ring in the direction of the proximal end of said first element.

28. The dental component as claimed in claim 27 wherein when the ring is not in said at least one locking angular orientation the first indexing member, the second indexing member, the third indexing member and the fourth indexing member form axial abutments preventing the bearing surface of the second element from coming to bear axially against the proximal end of said first element.

29. The dental component as claimed in claim 27 wherein first friction means enable a friction fit of the second element in said first element slowing movement in translation of the second element away from said first element along the first longitudinal axis (I-I).

30. The dental component as claimed in claim 27 wherein said first rotation indexing member is in the form of a longitudinal groove formed in the lateral wall of the first passage section of said first element and in which a radial projection forming the second rotation indexing member of the second element can be engaged when the bearing surface of the second element receives in axial bearing engagement the proximal end of said first element.

31. The dental component as claimed in claim 27 wherein:
the first axial retaining member is in the form of a shoulder in the first passage section of said first element,
the ring includes a radial protuberance at the periphery of the ring, said radial protuberance being adapted to bear against the shoulder when the ring is in the locking orientation.

32. The dental component as claimed in claim 27 wherein the first through-passage further includes a second passage section, said second passage section obliquely extending the first passage section so that the first passage section and the second passage section form a non-zero angle (A) between them.

33. A first element for the individual prosthetic restoration of a tooth of core type on which stratification is performed or of ceramic core type shaped to be assembled onto a dental sub-assembly as claimed in claim 22, which dental sub-assembly is itself shaped to be received on a dental implant, in which:
said first element includes a first through-passage including a first passage section extending from a proximal end of said first element along a first longitudinal axis (I-I),
said first element includes a first axial retaining member in the form of a shoulder forming an annular housing in the first passage section of said first element,
said first element includes at least one first rotation indexing member shaped to block rotation of said first element relative to the second element about the first longitudinal axis (I-I),
wherein said at least one first rotation indexing member is in the form of a longitudinal groove formed in the lateral wall of the first passage section of said first element extending from the proximal end of said first element and opening into said annular housing.

34. A method for ex-vivo assembly of a dental component as claimed in claim 27, comprising the following steps:
a) inserting the shank of the first screw in the ring,
b) inserting the ring and the first screw head in the first passage section by axial movement in translation along the first longitudinal axis (I-I) from the proximal end of the first element so as to cause the ring to reach the predetermined axial position,
c) causing the ring to pivot about the first longitudinal axis (I-I) to bring it into the locking orientation,
d) mounting the second element on the proximal end of the first element by engaging the shank of the first screw 8 in the second through-passage until the bearing surface of the second element is brought to bear against the proximal end of the first element.
